(19) United States
(12) Patent Application Publication
(10) Pub. No.: US 2022/0397951 A1
(43) Pub. Date: Dec. 15, 2022

(54) POWER SUPPLY DEVICE

(71) Applicant: Lenovo (Singapore) Pte. Ltd., Singapore (SG)

(72) Inventors: Limin Xiao, Kanagawa (JP); Moriyuki Tsuchihashi, Kanagawa (JP)

(73) Assignee: Lenovo (Singapore) Pte. Ltd., Singapore (SG)

(21) Appl. No.: 17/717,459

(22) Filed: Apr. 11, 2022

(30) Foreign Application Priority Data
Jun. 14, 2021 (JP) 2021-098818

(51) Int. Cl. G06F 1/3212; G06F 1/3296

(52) U.S. Cl. CPC G06F 1/3212; G06F 1/3296

(57) ABSTRACT

A power supply device includes: a display power supply circuit that receives a voltage and outputs a power supply at a predetermined voltage to a display; and a voltage switching circuit configured to, when a voltage value of a battery is equal to or higher than a predetermined value, output a first voltage to the display power supply circuit, the first voltage being based on the voltage that the battery outputs, and when a voltage value of the battery is less than the predetermined value, outputs a second voltage higher than the first voltage to the display power supply circuit, the second voltage being based on the voltage that the battery outputs.

### CROSS-REFERENCE TO RELATED APPLICATIONS

This application claims priority to Japanese Patent Application No. 2021-98818 filed on Jun. 14, 2021, the contents of which are hereby incorporated herein by reference in their entirety.

### TECHNICAL FIELD

The present disclosure relates to a power supply device.

### BACKGROUND

Technology has been known for a display device having light emitting elements that are organic light emitting diodes (OLEDs), the display device including a power supply circuit to supply electric power for driving these light emitting elements.

### SUMMARY

A power supply device according to one aspect of the present disclosure includes: a display power supply circuit that receives a voltage and outputs a power supply at a predetermined voltage to a display; and a voltage switching circuit configured to, when a voltage value of a battery is equal to or higher than a predetermined value, output a first voltage to the display power supply circuit, the first voltage being based on the voltage that the battery outputs, and when a voltage value of the battery is less than the predetermined value, output a second voltage higher than the first voltage to the display power supply circuit, the second voltage being based on the voltage that the battery outputs.

### BRIEF DESCRIPTION OF THE DRAWINGS

FIG. 1 illustrates a basic configuration example of a 2S battery that supplies electric power to an OLED display.

FIG. 2 illustrates the relationship among the output voltage range of the 2S battery, the input voltage range of the display power supply unit, and the output voltage range obtained by boosting the 2S battery.

FIG. 3 illustrates an example of the power supply device.

FIG. 4 illustrates the relationship between the input power and the power consumption of the display power supply unit.

FIG. 5 illustrates a configuration example of the voltage switching unit.

FIG. 6 illustrates a configuration example of the voltage switching unit.

FIG. 7 illustrates a configuration example of the voltage switching unit.

### DETAILED DESCRIPTION

### Background Leading to Embodiments

The present embodiment relates to a power supply device that supplies electric power to various types of electronic apparatuses including a display for display operation on the display. In the present embodiment, the display is configured as an OLED display having organic light emitting diodes (OLEDs). The OLEDs are self-luminous display elements. The OLED display may be configured to be a touch panel.

The electronic apparatus of the present embodiment may be a clamshell type personal computer, which is called a laptop personal computer, a tablet terminal, a mobile phone, a smartphone, or an electronic organizer.

The electronic apparatus of this embodiment can be driven by a battery. In this case, the OLED display of the electronic apparatus also operates by receiving the electric power from the battery.

For the electronic apparatus of this embodiment, a 2S battery is used for the battery. A 2S battery refers to a battery having two battery cells connected in series to output power within a predetermined voltage range. The 2S battery has many advantages when used in electronic apparatuses in terms of size and cost, for example.

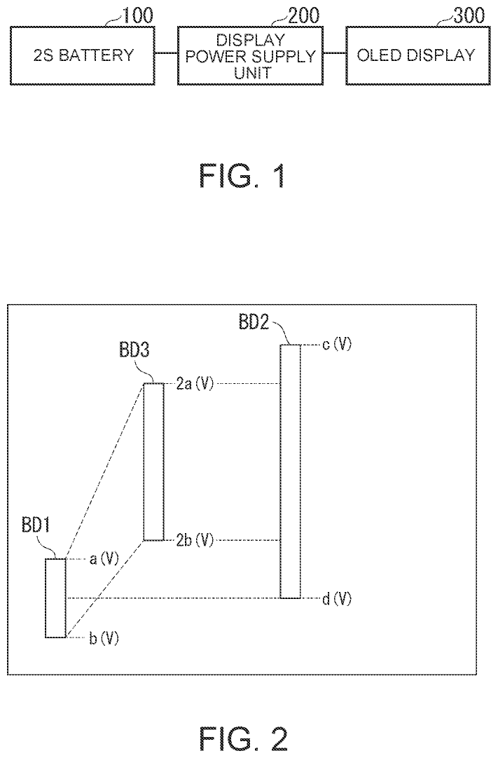

FIG. 1 illustrates a basic configuration example of an electronic apparatus including a 2S battery 100 that supplies electric power to an OLED display 300.

The voltage output from the 2S battery 100 is supplied to a display power supply unit 200 (an example of a display power supply circuit).

The display power supply unit 200 stabilizes the input voltage at a predetermined voltage value, and supplies power with the stabilized voltage to the OLED display 300. The display power supply unit 200 may be configured as a single integrated circuit (IC) such as an electro luminescence (EL) power supply IC.

The OLED display 300 is driven for displaying by the power supplied from the display power supply unit 200.

FIG. 2 illustrates the relationship between the output voltage range of the 2S battery 100 and the input voltage range of the display power supply unit 200 in the present embodiment.

The voltage value output from the 2S battery 100 changes with the stored amount of power (amount of charge) in the 2S battery 100. In one example, the output voltage range of the 2S battery 100 is the voltage range defined as usable based on the specifications of the 2S battery 100.

The input voltage range of the display power supply unit 200 is the guaranteed range in which the display power supply unit 200 outputs stabilized power at a predetermined voltage value.

The output voltage range BD1 of the 2S battery 100 is a voltage range from the upper limit value a(V) to the lower limit value b(V).

The input voltage range BD2 of the display power supply unit 200 is from the upper limit c(V) to the lower limit d(V). This means that the display power supply unit 200 requires the input of a voltage within the range specified as the input voltage range BD2.

The following describes an example where the upper and lower limit values a(V) and b(V) of the output voltage range BD1 of the 2S battery 100 are 9 V (a=9) and 5 V (b=5), respectively, and the upper and lower limit values c(V) and d(V) of the input voltage range BD2 are 20 V (a=10) and 7 V (b=7), respectively.

As can be seen from FIG. 2, while the upper limit value a(V) of the output voltage range BD1 of the 2S battery 100 falls within the input voltage range BD2 of the display power supply unit 200, the lower limit value b(V) of the output voltage range BD1 is lower than the lower limit d(V) of the input voltage range BD2. That is, the display power supply unit 200 can operate normally when the 2S battery 100 has the amount of charge that is above a certain level so as to output a voltage value of d(V) or higher. However, when the amount of charge falls below the certain level due to the use of the 2S battery 100, the 2S battery 100 does not output the voltage value above d(V). Then, the display power supply unit 200 may not operate normally. In this way, the output voltage range BD1 of the 2S battery 100 does not match the input voltage range BD2 that the display power supply unit 200 requires.

As one countermeasure, the voltage output from the 2S battery 100 may be boosted and then supplied to the display power supply unit 200. FIG. 2 illustrates the output voltage range BD3, which is obtained by doubling the voltage output from the 2S battery 100, in addition to the output voltage range BD1 of the 2S battery 100 and the input voltage range BD2 of the display power supply unit 200. The output voltage range BD3 ranges from the upper limit value 2a(V) to the lower limit value 2b(V). In this case, the upper limit value 2a(V) is 18V and the lower limit value 2b(V) is 10 V. This output voltage range BD3 is obtained by boosting the voltage of the 2S battery 100. Alternatively, the output voltage range BD3 is obtained by using a 4S battery, which includes four battery cells connected in series.

In this way, the voltage of the 2S battery 100 may be boosted and the resulting output voltage range BD3 may be supplied to the display power supply unit 200. In this case, the display power supply unit 200 receives the voltage that falls within the input voltage range BD2 regardless of the voltage drop due to the decrease in the stored amount of power in the 2S battery 100.

However, the efficiency of the display power supply unit 200 decreases as the input voltage increases. Therefore, when the display power supply unit 200 operates simply in the output voltage range BD3, the display power supply unit 200 tends to operate with low efficiency. Further, the output voltage range BD3 is created by boosting the voltage output from the 2S battery 100 double. This means that a power loss also occurs at the stage of creating the output voltage range BD3 by boosting. For example, when considering factors such as the duration of the 2S battery 100 and the heat generation of electronic apparatus, the display power supply unit 200 is required to operate efficiently with as low loss as possible.

### First Embodiment

In view of the above, the present embodiment is configured so that the voltage supplied from the 2S battery 100 to the display power supply unit 200 is switchable between a 1X mode, in which the same voltage as the voltage that the 2S battery 100 supplies to the display power supply unit 200 is output, and a boosting mode, in which the voltage is boosted and then output, in accordance with the voltage value of the 2S battery 100. The following describes this configuration.

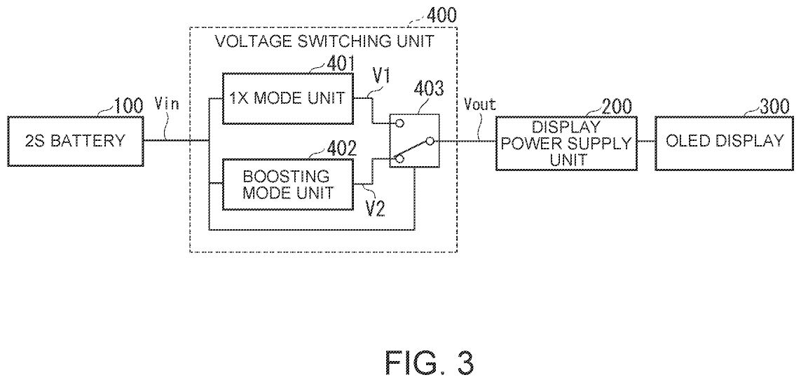

FIG. 3 illustrates a configuration example of the power supply device in this embodiment. The power supply device in this example supplies the power of the 2S battery 100 to the OLED display 300, and includes a display power supply unit 200 and a voltage switching unit 400. In FIG. 3, like numerals indicate like components of FIG. 1, and their description are omitted.

As illustrated in FIG. 3, the power supply device of the present embodiment includes the voltage switching unit 400 that is inserted between the 2S battery 100 and the display power supply unit 200. The voltage switching unit 400 includes a 1X mode unit 401, a boosting mode unit 402, and a switch 403.

The voltage switching unit 400 receives the input voltage Vin, which is the voltage that the 2S battery 100 outputs.

The 1X mode unit 401 outputs the first voltage V1 having a voltage value equivalent to the input voltage Vin. In this embodiment, the 1X mode unit 401 may simply output the input voltage Vin as it is, for example.

The boosting mode unit 402 outputs a second voltage V2 obtained by boosting the input voltage Vin. The boosting mode unit 402 may be configured to include a boosting circuit. The configuration of the boosting circuit in the boosting mode unit 402 is not particularly limited. A DC-DC converter including a switching circuit may be used because of its high efficiency.

The switch 403 performs switching between the 1X mode and the boosting mode in accordance with the input voltage Vin. Specifically, when the input voltage Vin is equal to or higher than a threshold, this is the case of the 1X mode. Then, the switch 403 connects the terminal so that the output voltage Vout, which is the first voltage V1 that the 1X mode unit 401 outputs, is output to the display power supply unit 200. When the input voltage Vin is less than the threshold, this is the case of the boosting mode. Then, the switch 403 connects the terminal so that the output voltage Vout, which is the second voltage V2 that the boosting mode unit 402 outputs, is output to the display power supply unit 200.

In a specific example, the switching by the switch 403 may be made: assuming that the output voltage range BD1 in FIG. 2 is 9 V to 5 V and the input voltage range BD2 is 20 V to 7 V, the terminal is switched by setting the threshold at V. In this case, the boosting mode unit 402 may be configured to boost the input voltage Vin double and output it as the second voltage V2.

With this configuration, when the voltage of the 2S battery 100 is 7 V or higher, this is the case of the 1X mode. Then, the voltage switching unit 400 supplies the output voltage Vout that is the first voltage V1, which is equivalent to the input voltage Vin from the 2S battery 100, to the display power supply unit 200. In this case, the display power supply unit 200 will operate with the received input voltage in the range of 9 V to 7 V. That is, the display power supply unit 200 receives the input of a voltage in the range of 2 V at the lower limit end in the input voltage range BD2. This sufficiently suppresses the decrease in efficiency.

When the voltage of the 2S battery 100 is less than 7 V, this is the case of the boosting mode. Then, the voltage switching unit 400 supplies the output voltage Vout that is the second voltage V2, which is obtained by boosting the input voltage Vin from the 2S battery 100 double, to the display power supply unit 200. In this case, the display power supply unit 200 will operate with the received input voltage in the range of less than 14 V and 10 V or more. The range of the voltage input to the display power supply unit 200 in this boosting mode is higher than that in the 1X mode. However, in this case, the output voltage Vout input to the display power supply unit 200 does not exceed 14 V. Therefore, there is sufficient margin for the input voltage range BD2 whose upper limit is 20 V, and this case also suppresses the decrease in efficiency.

In this way, this embodiment is configured so that the voltage switching unit 400 performs switching of the output voltage Vout to be supplied to the display power supply unit 200 in accordance with the voltage value (input voltage Vin) of the 2S battery 100. This improves the efficiency of the display power supply unit 200, compared to the configuration of constantly supplying the boosted voltage of the 2S battery 100 to the display power supply unit 200.

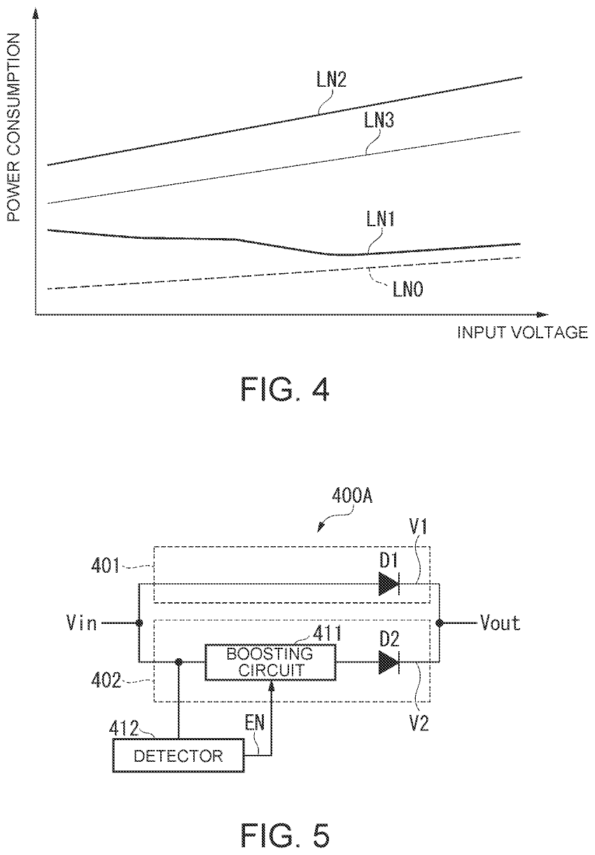

FIG. 4 illustrates the power consumption of the display power supply unit 200 and the voltage switching unit 400 with respect to the input voltage Vin from the 2S battery 100. This power consumption corresponds to the output power from the 2S battery 100.

In FIG. 4, line LN1 represents the power consumption obtained by voltage switching by the voltage switching unit 400 in this embodiment. Line LN2 represents the power consumption when these units operate in the output voltage range BD3 (FIG. 2) obtained by boosting the input voltage Vin from the 2S battery 100. Line LN3 represents the power consumption when these units operate in the output voltage range BD3 (FIG. 2) obtained using a 4S battery (input voltage Vin×2). Line LN0 represents the power consumption of the display power supply unit 200. The difference between the power consumption indicated by each of these lines LN1, LN2, and LN3 and the power consumption of the display power supply unit 200 indicated by line LN0 corresponds to the power consumption of the voltage switching unit 400.

As can be seen from FIG. 4, under the same condition for the input voltage Vin, the present embodiment enables reduction in power consumption, compared with the cases of boosting the input voltage Vin and using the 4S battery. In this way, the present embodiment improves the efficiency.

### Second Embodiment

Next, the following describes a second embodiment. The voltage switching unit 400 of FIG. 3 indicates a specific configuration of the first embodiment and also illustrates the concept for the configuration of the second embodiment. Referring to FIG. 5, a configuration example of a voltage switching unit 400A according to this embodiment is described based on the configuration concept of FIG. 3. In this drawing, like numerals indicate like components of FIG. 3, and their description are omitted. Similarly to FIG. 3, this embodiment also is configured so that the input voltage Vin is output from the 2S battery 100, and the output voltage Vout is supplied to the display power supply unit 200.

In the voltage switching unit 400A of FIG. 5, the 1X mode unit 401 includes a diode D1 inserted between the input voltage Vin and the output voltage Vout. The input voltage Vin is output via the diode D1 to become a first voltage V1.

In the voltage switching unit 400A, the boosting mode unit 402 includes a boosting circuit 411 and a diode D2. The boosting circuit 411 boosts the input voltage Vin for outputting. The voltage output from the boosting circuit 411 is applied to the diode D2. The voltage output through the diode D2 becomes a second voltage V2. The boosting circuit 411 operates when an enable signal EN is output from a detector 412, and stops the operation when the enable signal EN is not output.

An ideal diode may be used for the diode D1 and the diode D2.

The detector 412 detects the input voltage Vin. When the detected input voltage Vin is equal to or higher than the threshold (e.g., 7 V), the detector 412 does not output an enable signal EN to stop the operation of the boosting circuit 411. When the detected input voltage Vin is less than threshold, the detector 412 outputs an enable signal EN to operate the boosting circuit 411.

With such a configuration, when the input voltage Vin is equal to or higher than the threshold, the operation of the boosting circuit 411 stops, so that the diode D1 is conducting with the input voltage Vin. In this case, the input voltage Vin is output as the first voltage V1 through the diode D1, and the output first voltage V1 becomes the output voltage Vout.

When the input voltage Vin is less than the threshold, the voltage boosting circuit 411 operates, and the boosting circuit 411 outputs a voltage, for example, the doubled input voltage Vin as the second voltage V2. In this case, the voltage applied to the diode D2 from the boosting circuit 411 is higher than the voltage applied to the diode D1. As a result, the diode D1 is non-conducting and the diode D2 is conducting. As a result, the voltage output from the boosting circuit 411 is output as the second voltage V2 through the diode D2, and the output second voltage V2 becomes the output voltage Vout.

The switch 403 in FIG. 3 is configured as hardware that performs switching physically between the first voltage V1 and the second voltage V2, to which the output voltage Vout is connected. In this case, the output voltage Vout temporarily drops during switching by the switch 403. Specifically, when the terminal of the switch 403 is switched from the first voltage V1 to the second voltage V2 in response to the timing when the input voltage Vin becomes less than the threshold, the output voltage Vout first drops a voltage lower than the first voltage V1 when transitioning from the first voltage V1 to the second voltage V2, which is higher than the first voltage V1, and then rises to the second voltage V2. When the output voltage Vout drops to a voltage lower than the first voltage V1, the display power supply unit 200 may fail to operate normally, which may affect the display of the OLED display 300.

The configuration of the present embodiment omits such a switch 403 that performs switching of the terminal physically, and then enables switching between the 1X mode and the boosting mode. According to the configuration of the present embodiment, the output voltage Vout does not drop when switching between the 1X mode and the boosting mode. The present embodiment therefore ensures the normal operation of the display power supply unit 200, and does not affect the display of the OLED display 300.

Further, after the input voltage Vin changes from a voltage equal to or higher than the threshold to a value less than the threshold to change the mode from the 1X mode to the boosting mode, the input voltage Vin may fluctuate around the threshold in a short time for some reason. In this case, the 1X mode and the boosting mode are unexpectedly switched in a short time. Such an unexpected and frequent switching between the 1X mode and the boosting mode should be preferably avoided.

To this end, the detector 412 operates about the output of the enable signal EN as follows. Specifically, the detector 412 is configured to compare the input voltage Vin with a first threshold in the state of the 1X mode.

When the input voltage Vin becomes less than the first threshold, the detector 412 outputs the enable signal EN to switch to the boosting mode. The detector 412 is configured to compare the input voltage Vin with a second threshold that is higher than the first threshold in the state of the boosting mode. The detector 412 may be configured to, when the input voltage Vin exceeds the second threshold in the state of the boosting mode, stop the output of the enable signal EN to switch from the boosting mode to the 1X mode. The detector 412 may be configured to, when the input voltage Vin keeps a state of being higher than the second threshold in the boosting mode for a predetermined standby duration (e.g., a few seconds), stop the output of the enable signal EN to switch from the boosting mode to the 1X mode.

This configuration avoids the phenomenon of frequent switching between the 1X mode and the boosting mode due to small fluctuations in input voltage Vin after the transition from the 1X mode to the boosting mode.

Such a configuration may also be applied to the configuration of the first embodiment illustrated in FIG. 3.

### Third Embodiment

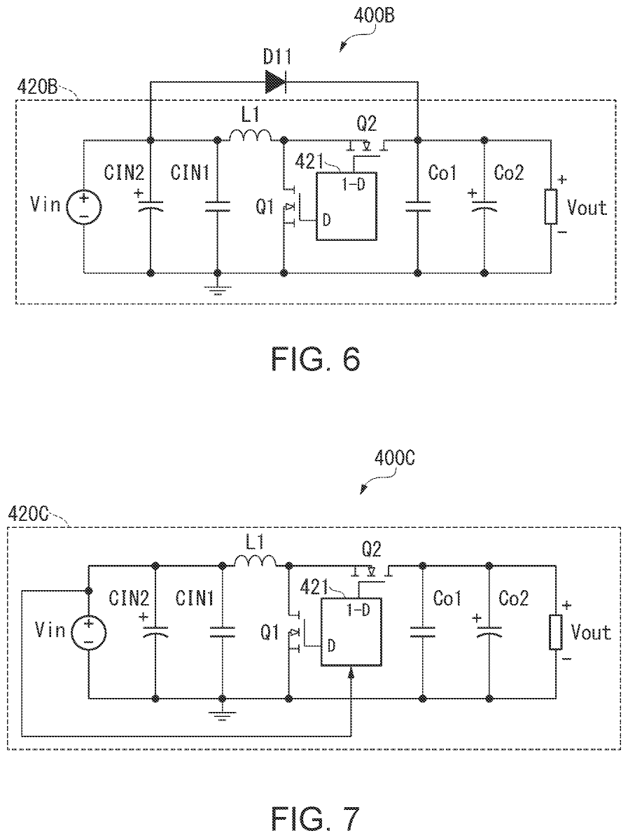

Next, the following describes a third embodiment. FIG. 6 illustrates a configuration example of a voltage switching unit 400B in this embodiment. The voltage switching unit 400B of FIG. 6 also is configured so that the input voltage Vin is output from the 2S battery 100, and the output voltage Vout is output to the display power supply unit 200.

The voltage switching unit 400B in FIG. 6 includes a DC-DC converter 420B and a diode D11. The DC-DC converter 420B performs switching of the input voltage Vin with a switching circuit (inductor L1, switching elements Q1, Q2, switching drive circuit 421). The DC-DC converter 420B interrupts the input voltage Vin by the switching operation of the switching circuit, and generates a DC voltage stabilized to a predetermined voltage value that is the voltage across the output capacitors Co1 and Co2. The DC voltage generated in this way is output as the output voltage Vout.

The voltage value (specified voltage value) of the output voltage Vout output by the operation of the DC-DC converter 420B alone without the diode D11 is set to be equivalent to the voltage value corresponding to the threshold for the switching between the 1X mode and the boost mode. Specifically, the specific voltage value may be 7 V, corresponding to the example of FIG. 2.

The diode D11 has an anode connected to the positive electrode of the input voltage Vin and a cathode connected to the positive electrode of the output voltage Vout. That is, the diode D11 is configured so as to be able to output the input voltage Vin as the output voltage Vout by bypassing the switching circuit in the boosting circuit 411. In one example, an ideal diode may be used for the diode D11.

In the present embodiment, when the input voltage Vin is higher than the threshold, the voltage on the input side of the DC-DC converter 420B becomes larger than the specified voltage value of the DC-DC converter 420B. In this way, when the input voltage Vin is higher than the threshold, the diode D11 is conducting, so that the voltage value corresponding to the input voltage Vin at this time is obtained as the output voltage Vout across the output capacitors Co1 and Co2 connected in parallel. In other words, this is the case of the 1X mode, and the voltage switching unit 400B outputs the output voltage Vout with the voltage value corresponding to the input voltage Vin.

In contrast, when the input voltage Vin is the threshold (specified voltage value) or lower, the diode D11 is not conducting. In this case, the voltage switching unit 400B has a state where the DC-DC converter 420B alone operates, similarly to the case of omitting the diode D11. That is, this is the case of the boosting mode, and the voltage switching unit 400B boosts the input voltage Vin of less than 7 V to the output voltage Vout of 7 V, which is the specified voltage value, and supplies it to the display power supply unit 200.

Such a configuration of the voltage switching unit 400B of the present embodiment also outputs the input voltage Vin as the output voltage Vout when the voltage value of the input voltage Vin from the 2S battery 100 is equal to or higher than the predetermined value. When the voltage value of the input voltage Vin is less than the predetermined value, the output voltage Vout with the specified voltage value is output.

In the present embodiment, the output voltage Vout in the boosting mode is not boosted to double the input voltage Vin, and the boosting is suppressed to the specified voltage value corresponding to the threshold of the input voltage Vin. This therefore further improves the efficiency of the display power supply unit 200. In the present embodiment also, the output voltage Vout does not drop because the terminal is not switched for switching between the 1X mode and the boosting mode.

### Fourth Embodiment

Next the following describes a fourth embodiment. FIG. 7 illustrates a configuration example of a voltage switching unit 400C in this embodiment. The voltage switching unit 400C of FIG. 7 also is configured so that the input voltage Vin is output from the 2S battery 100, and the output voltage Vout is output to the display power supply unit 200.

The voltage switching unit 400C in FIG. 7 includes a DC-DC converter 420C. In this drawing, like numerals for the DC-DC converter 420C indicate like components of the DC-DC converter 420B in FIG. 6, and their description are omitted.

In this DC-DC converter 420C, the switching drive circuit 421 receives the input voltage Vin as a detection voltage.

When the input voltage Vin input as the detection voltage is equal to or higher than a threshold, this is the case of the 1X mode. Then, the switching drive circuit 421 keeps the switching element Q1 in the off state without performing the switching operation, and keeps the switching element Q2 in the on state without performing the switching operation.

In this state, the DC-DC converter 420C stops the operation of the DC-DC conversion, and then the input voltage Vin is output as the output voltage Vout via the inductor L1 and the switching element Q2. In other words, this is the case of the 1X mode, and the output voltage Vout with the voltage value corresponding to the input voltage Vin is output.

When the input voltage Vin input as a detection voltage is less than the threshold, the switching drive circuit 421 makes the switching elements Q1 and Q2 perform the switching operation for DC-DC conversion. In other words, this is the case of the boosting mode, and the output voltage Vout with the specified voltage value higher than the input voltage Vin is output.

Similar to the third embodiment, this configuration also further improves the efficiency of the display power supply unit 200 because the output voltage Vout output in the boosting mode is suppressed to the boosting to the specified voltage value corresponding to the threshold of the input voltage Vin. In the present embodiment also, the output voltage Vout does not drop because the terminal is not switched for switching between the 1X mode and the boosting mode.

### MODIFIED EXAMPLES

The following describes modified examples of these embodiments. The following modified examples may be applied to any of the above embodiments. The following modified examples may also be combined as appropriate.

### First Modified Example

The electronic apparatus may use an AC adaptor in addition to the 2S battery 100 as a power source. In this case, when the AC adapter is connected to the electronic apparatus, it may not be necessary to consider the increase in power consumption at the display power supply unit 200. Then, the voltage switching unit (400, 400A, 400B, 400C) may operate in the boosting mode when the AC adapter is connected to the electronic apparatus.

### Second Modified Example

To prevent the frequent switching between the 1X mode and the boosting mode, the voltage switching unit (400, 400A, 400B, 400C) may store information (mode switching history information) on the history of switching between the 1X mode and the boost mode in the past. Then, the voltage switching unit (400, 400A, 400B, 400C) may change the threshold based on the stored mode switching history information. The second embodiment is configured so that the first and second thresholds and the standby duration are set for switching from the boosting mode to the 1X mode. In this case, the voltage switching unit may change the first and second thresholds and the standby duration as needed based on the stored mode switching history information.

### Third Modified Example

In the above embodiments, the switching is made between the 1X mode and the boosting mode. In this modified example, a first boosting mode and a second boosting mode with different degrees of boosting may be set, and switching between the first boosting mode and the second boosting mode may be performed in accordance with the input voltage Vin.

### Fourth Modified Example

The battery that supplies the input voltage Vin is not limited to a 2S battery. The display driven by the power supply device of the present embodiment may be other than an OLED display.

The specific configuration of the present disclosure is not limited to the above-described embodiments that have been described in detail referring to the drawings, and also includes design modifications or the like within the scope of the present disclosure. The configurations described in the above embodiments can be combined as needed unless such a combination is inconsistent with present disclosure.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A power supply device comprising:
a display power supply circuit that receives a voltage and outputs a power supply at a predetermined voltage to a display; and
a voltage switching circuit configured to:
when a voltage value of a battery is equal to or higher than a predetermined value, output a first voltage to the display power supply circuit, wherein the first voltage is based on the voltage that the battery outputs, and
when a voltage value of the battery is less than the predetermined value, output a second voltage higher than the first voltage to the display power supply circuit, wherein the second voltage is based on the voltage that the battery outputs.

2. The power supply device according to claim 1, wherein the voltage switching circuit does not boost a voltage that the battery outputs and outputs the voltage as the first voltage, and boosts a voltage that the battery outputs and outputs the voltage as the second voltage.

3. The power supply device according to claim 1, wherein the battery has an output voltage range with an upper limit that is within an allowable range of an input voltage specified for the display power supply circuit, and a lower limit that is lower than the allowable range of the input voltage.

4. The power supply device according to claim 1, wherein the battery includes a plurality of predetermined battery cells connected in series.

5. The power supply device according to claim 1, wherein the display includes an organic light emitting diode (OLED) display.
